(19) United States
(12) Patent Application Publication
(10) Pub. No.: US 2008/0154714 A1
(43) Pub. Date: Jun. 26, 2008

(54) PERSONALIZED E-COUPONS FOR MOBILE COMMUNICATION DEVICES

(75) Inventors: Zicheng Liu, Bellevue, WA (US); Philip A. Chou, Bellevue, WA (US); Zhengyou Zhang, Redmond, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/614,391

(22) Filed: Dec. 21, 2006

(51) Int. Cl. G06Q 30/00; G01C 21/00

(52) U.S. Cl. 705/14; 701/207

(57) ABSTRACT

A technique for providing and receiving personalized e-coupons is presented. In general, the technique involves an e-coupon provider sending e-coupons to a user of a mobile communication device, such as a cellular telephone or PDA, which are personalized in various ways so as to make them attractive to the user. In one embodiment, the e-coupons are provided based on location information received from the mobile communication device. In another embodiment, the e-coupons are provided based on the user's purchasing history. The mobile communication device that receives e-coupons from the provider includes an e-coupon handler program to facilitate the procurement and receipt of the e-coupons. In general, the e-coupon handler receives e-coupons and displays them to the user on a display of the mobile communication device. The e-coupons could have been requested by the e-coupon handler, or pushed to it by the e-coupon provider.

### BACKGROUND

The use of wireless, mobile communication devices, such as cellular telephones, and Personal Digital Assistants (PDAs), and the like, has fast become a dominant theme in today's society. People have become reliant on these mobile devices and are continually demanding new features. One such feature that has recently come onto the scene is the electronic coupon (popularly referred to as an e-coupon). E-coupons, like their traditional paper counterparts, provide an incentive to buyers to purchase goods and services from a commercial enterprise by offering a discount, or free items, or some other inducement. However, unlike traditional paper coupons, e-coupons are provided to a person's mobile communication device and brought to the enterprise offering the e-coupon on the device. Thus, e-coupons can be delivered and accessed anywhere and at any time. Typically, the e-coupons are provided to the mobile communication device via a short messaging service (SMS), multi-media messaging service (MMS), or enhanced messaging service (EMS).

One of the problems with current e-coupon provider schemes is that on the mobile communication device a user receives numerous e-coupons for goods and services they are not interested in purchasing. Thus, rather than being the welcomed benefit the enterprise offering the coupon had hoped, an e-coupon can become an unwanted intrusion.

### SUMMARY

In the present technique an e-coupon provider provides e-coupons to a user of a mobile communication device, which is personalized in various ways so as to make them attractive to the user. In one embodiment, the e-coupons are provided based on location information received from the mobile communication device.

This location information includes routes and destinations frequented by the user. The location information is analyzed to identify enterprises offering e-coupons which are proximate to a frequent route or destination of the user. The e-coupon provider then generates one or more e-coupons associated with the identified enterprises and sends them to the mobile communication device. The location information can also include the current location of the mobile communication device. In that embodiment, the e-coupon provider generates one or more e-coupons associated with enterprises that are proximate to the mobile communication device's current location.

In another embodiment of the present technique, the e-coupons are provided by the e-coupon provider based on purchasing information that includes data concerning a user's past redemption and sometimes non-redemption of e-coupons. This purchasing information can come from the mobile communication device, enterprises that issued the redeemed e-coupons, or other sources. The information is analyzed to determine what goods or services, or both, the user finds attractive. The e-coupon provider then generates one or more e-coupons associated with enterprises that sell the identified goods and services, and sends them to the mobile communication device.

The mobile communication device that receives e-coupons from the aforementioned provider includes an e-coupon handler program to facilitate the procurement and receipt of the e-coupons. In general, the e-coupon handler receives e-coupons and displays them to the user on a display of the mobile communication device. The e-coupons could have been requested by the e-coupon handler, or pushed to it by the e-coupon provider.

It is noted that while the foregoing limitations in existing e-coupon schemes described in the Background section can be resolved by a particular implementation of an e-coupon technique according to the present invention, this is in no way limited to implementations that just solve any or all of the noted disadvantages. Rather, the present e-coupon technique has a much wider application as will become evident from the descriptions to follow.

It should also be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. In addition to the just described benefits, other advantages of the present invention will become apparent from the detailed description which follows hereinafter when taken in conjunction with the drawing figures which accompany it.

### DESCRIPTION OF THE DRAWINGS

The specific features, aspects, and advantages of the present invention will become better understood with regard to the following description, appended claims, and accompanying drawings where:

FIG. 1 is a diagram depicting a general purpose computing device constituting an exemplary system for implementing the present e-coupon technique.

FIG. 2 is a block diagram illustrating the architecture of an e-coupon provider program according to the present e-coupon technique.

FIG. 3 is a flow diagram generally outlining one embodiment of a procedure for the e-coupon provider to provide e-coupons to a user via a mobile communication device, where the e-coupons are generated based on location information provided by the mobile communication device.

FIG. 4 is a flow diagram generally outlining one embodiment of a procedure for providing a location-based reminder notice in response to a request from the user of a mobile communication device, where the e-coupon provider send the notice.

FIG. 5 is a flow diagram generally outlining another embodiment of a procedure for providing a location-based reminder notice in response to a request from the user of a mobile communication device, where the e-coupon handler program running on the device generates the notice based on information provided by the e-coupon provider.

FIG. 6 is a flow diagram generally outlining one embodiment of a procedure for the e-coupon provider to provide e-coupons to a user via a mobile communication device, where the e-coupons are generated based on a user's purchasing history.

FIG. 7 is a block diagram illustrating the architecture of an e-coupon handler program according to the present e-coupon technique.

FIG. 8 is a flow diagram generally outlining one embodiment of a procedure for the e-coupon handler to receive and display e-coupons to the user of the mobile communication device in accordance with the present e-coupon technique.

FIG. 9 is a flow diagram generally outlining one embodiment of a procedure for the e-coupon handler to handle a location-based reminder notice, where the e-coupon provider sends the notice.

FIG. 10 is a flow diagram generally outlining another embodiment of a procedure for the e-coupon handler to handle a location-based reminder notice, where the e-coupon handler generates the notice based on information provided by the e-coupon provider.

### DETAILED DESCRIPTION

In the following description of embodiments of the present invention reference is made to the accompanying drawings which form a part hereof, and in which are shown, by way of illustration, specific embodiments in which the invention may be practiced. It is understood that other embodiments may be utilized and structural changes may be made without departing from the scope of the present invention.

### 1.0 The Computing Environment

Before providing a description of embodiments of the present personalized e-coupon technique, a brief, general description of a suitable computing environment in which portions thereof may be implemented will be described. The present personalized e-coupon technique is operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. In particular, an e-coupon provider program of the present technique can operate on any of these devices. On the other hand, an e-coupon handler program would typically operate on a mobile communication device, such as a cellular phone or PDA containing an appropriately-sized computing system.

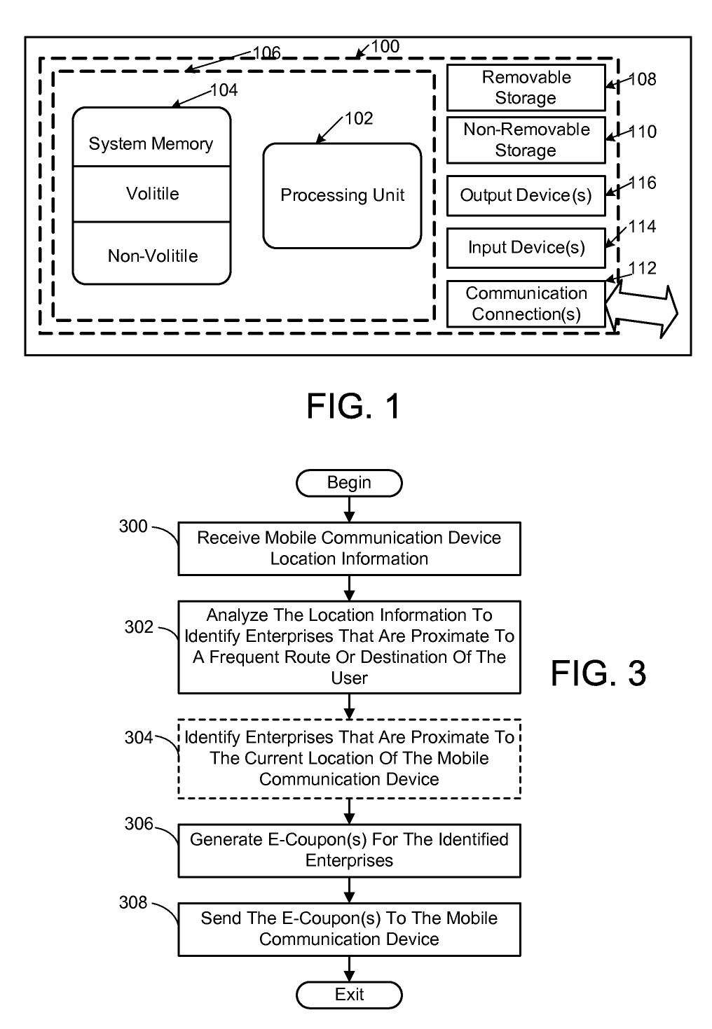

FIG. 1 illustrates an example of a suitable computing system environment. The computing system environment is only one example of a suitable computing environment and is not intended to suggest any limitation as to the scope of use or functionality of the present personalized e-coupon technique. Neither should the computing environment be interpreted as having any dependency or requirement relating to any one or combination of components illustrated in the exemplary operating environment. With reference to FIG. 1, an exemplary system for implementing the present personalized e-coupon technique includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110.

Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. All these devices are well know in the art and need not be discussed at length here.

The present personalized e-coupon technique may be described in the general context of computer-executable instructions, such as program modules, being executed by a computing device. Generally, program modules include routines, programs, objects, components, data structures, etc. that perform particular tasks or implement particular abstract data types. The present personalized e-coupon technique may also be practiced in distributed computing environments where tasks are performed by remote processing devices that are linked through a communications network. In a distributed computing environment, program modules may be located in both local and remote computer storage media including memory storage devices.

The exemplary operating environment having now been discussed, the remaining parts of this description section will be devoted to a description of the program modules embodying the present personalized e-coupon technique.

### 2.0 Personalized E-Coupons

Presonalized e-coupons are e-coupons that have been tailored to be attractive to the user of a mobile communication device, such as a cellular telephone or PDA, in that they are displayable on a display of the device and concern goods or services the user is likely to be interested in buying. In addition, these e-coupons can be personalized so that they contain information that identifies the user. In this way redemption of an e-coupon can be tracked and associated with a particular buyer.

In cases where these personalized e-coupons are provided to a mobile communication device via SMS, MMS, or EMS, the device should be configured to receive messages via at least one of these types of services. In addition, some of the embodiments of the present technique depend on information concerning the present and past locations of the mobile communication device to represent a user's frequent routes, destination and/or current location. In these embodiments, the mobile communication device should be capable of periodically ascertaining its location (e.g., every 5 seconds) using for example, global positioning system (GPS) or cellular location schemes.

The present personalized e-coupon technique involves an e-coupon provider program that runs on a computing system such as one of those described in the computing environment section and an e-coupon handler program that runs on such a computing system contained in a mobile communication device. The computing system associated with the e-coupon provider is capable of communication with, and sending e-coupons and other information to, the computing system associated with the mobile communication device using any appropriate wireless communication format such as cellular internet, bluetooth, wi-fi, and so on. The e-coupons sent by the e-coupon provider are associated with commercial enterprises, such as a retail store, a restaurant, and the like, that offer e-coupons to attract customers.

Each mobile communication device user contacts the e-coupon provider and signs up to be a member. A membership account is created for the user, which can include assigning a unique customer number to the account that is used to identify the user. In addition, the user downloads the e-coupon handler program to his or her mobile communication device.

Each time a user checks out at one of the aforementioned enterprises and redeems an e-coupon offered by that enterprise, purchasing information such as the enterprise involved, the good or service bought with the e-coupon, the price paid, and possibly the purchaser's identify (by name or using the aforementioned customer number), is either captured by the e-coupon handler or captured by the enterprise, or both. This information is given to the e-coupon provider as will be described in more detail later. It is noted that the transfer of e-coupon data to the enterprise when a user redeems an e-coupon, can be accomplished using any appropriate method. For example, the e-coupon could be visually scanned while displayed on the mobile communication device. The displayed e-coupon may have a bar code for this purpose. Alternately, the e-coupon information could be transferred via a cellular telephone signal, bluetooth signal, infrared signal, or any other type of wireless signal the mobile communication device is capable of transmitting. Still further the data could be transferred via a removable wire connection to the mobile communication device.

Given the foregoing basis for the present e-coupon technique, the following sections will more fully describe the architecture and operation of the e-coupon provider and handler programs.

### 2.1 Personalized E-Coupon Provider Architecture

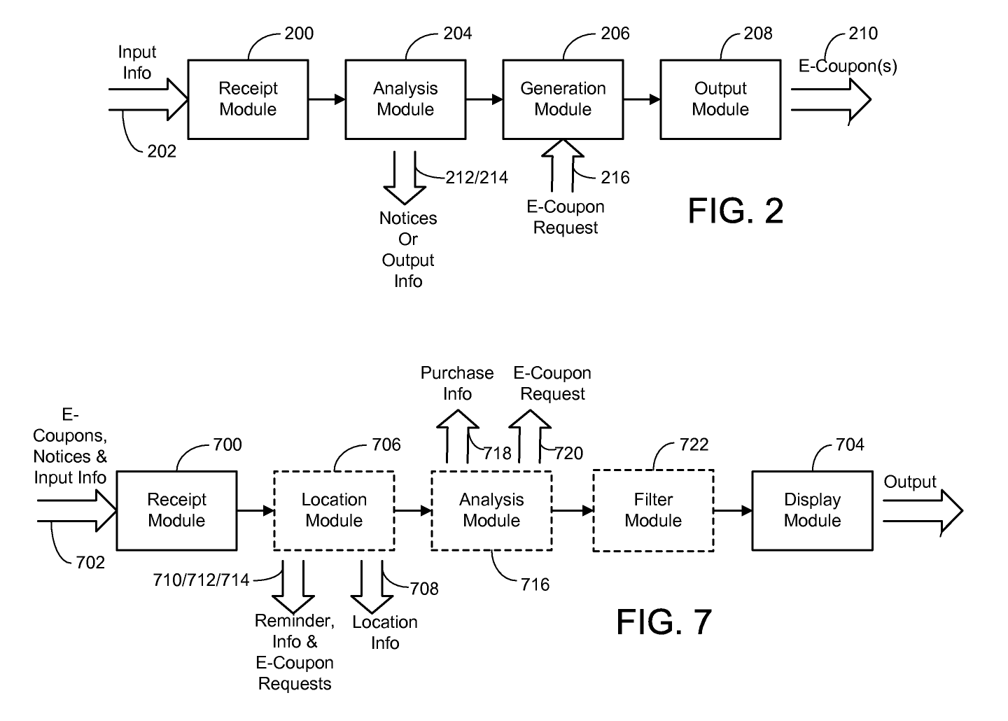

Referring to FIG. 2, the general architecture of the program modules making up the e-coupon provider of the present technique is shown. A receipt module 200 inputs several different kinds of information 202 from mobile communication devices, as will be described in greater detail later. The received information is then forwarded to an analysis module 204. In a first set of embodiments, the analysis module 204 uses the received information to identify enterprises offering e-coupons that would be attractive to the user of the mobile communication device. In another embodiment, the analysis module 204 additionally provides proximity notices 212 or information on enterprises offering e-coupons 214 to a mobile communication device. These aspects of the analysis module will also be described in greater detail shortly. A generation module 206 takes the enterprise data output from the analysis module 204, and generates one or more e-coupons for goods and services offered by the identified enterprises that are deemed to be of probable interest to the user of the mobile communication device. This e-coupon generation action can be done automatically, or in response to an e-coupon request 216 received from a mobile communication device. Once generated, the e-coupons 210 are provided to a mobile communication device for use by a user via the output module 208.

Given the above-described basic architecture of the e-coupon provider, the following sections will describe various embodiments of the present technique that employ the architecture to provide e-coupons and notices to users of mobile communication devices.

### 2.1.1 Providing E-Coupons Based On Location Information

A first embodiment of the present technique that provides e-coupons to a mobile communication device based on location information, involves using data on frequent routes taken by a user and destinations frequented by the user. As mentioned previously, the mobile communication device can have the capability of ascertaining its current location. By periodically determining and noting the current location of the mobile communication device it is possible to establish routes frequently taken by the user or destinations frequented by the user. For example, if a route is taken at least a prescribed number of times (e.g. in average once a month in the past three month period), it would be deemed a frequent route. Similarly, if a user visited a particular destination at least a prescribed number of times (e.g., in average once a month in the past three month period), it would be deemed a frequented destination. Other more sophisticated analyses could be performed to establish the frequent route and destination information if desired. For example, one could build a statistic model of the user's traveling pattern based on the user's traveling history.

The frequent route and destination analysis can be performed by the mobile communication device. If so, this information would be provided to the e-coupon provider. Alternately, the raw current location data could be provided to the e-coupon provider by the mobile communication device. In this case, the aforementioned analysis module of the e-coupon provider would establish the frequent route and destination information.

FIG. 3 outlines one embodiment of the personalized e-coupon technique where the e-coupon provider provides one or more e-coupons to a user's mobile communication device based on location information. First, location information is received from the mobile communication device (300). As indicated previously, this information can be frequent routes and destinations of the user, or raw location data. The location information is then analyzed to identify enterprises that are offering e-coupons and which are proximate to a frequent route or destination of the mobile communication device's user (302). As noted above, if the raw location data is provided, the analysis would include first establishing the frequent routes and destinations. Optionally, if the raw location data is provided (either alone or in addition to the frequent route and destination information), the data can be used to identify enterprises offering e-coupons that are proximate (e.g., within a prescribed distance) to the current location of the mobile communication device (304). The optional nature of this last action is indicated by the broken line box in FIG. 3. Once enterprises are identified in the foregoing manner, e-coupons associated with those enterprises are generated (306) and provided to the mobile communication device (308). In regard to generating and providing the e-coupons, this could be done automatically by the e-coupon provider, or it could be done in response to a request for e-coupons from the user of the mobile communication device.

### 2.1.2 Location-Based Reminder Request

In addition to providing e-coupons to a user of a mobile communication device, the e-coupon provider can also notify, or assist in notifying, a user that he or she is nearby an enterprise that the user has indicated that they want to shop at, or that sells a good or service the user has indicated they want to buy. In a first mode, the e-coupon provider directly notifies the user via the mobile communication device. In a second mode, the e-coupon provider supplies information to the mobile communication device so that it can notify the user. Each of these modes will now be described.

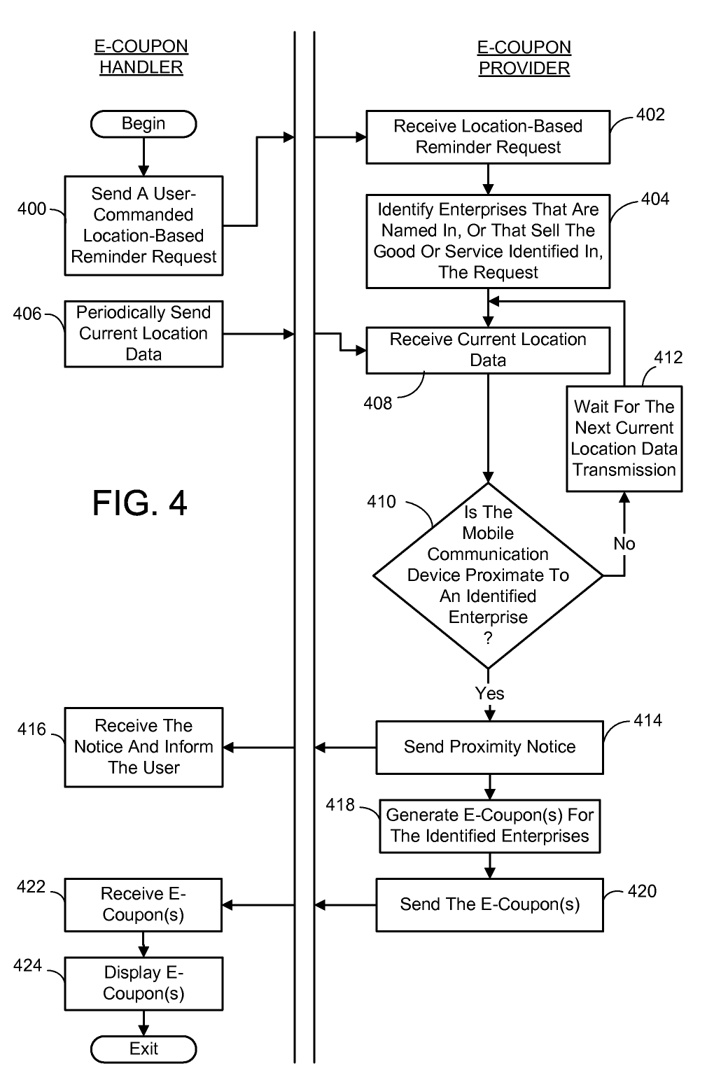

In the first mode, where the aforementioned e-coupon handler of the mobile communication device periodically provides current location data to the e-coupon provider, the location-based reminder request is implemented, in one embodiment, as shown in FIG. 4. First, a user-commanded location-based reminder request is sent from a user's mobile communication device to the e-coupon provider (400), and the provider receives it (402). The provider then identifies enterprises that are named in, or that sell the good or service identified in, the request (404). Meanwhile, the mobile communication device is periodically sending its current location data to the e-coupon provider (406). When the provider receives the first current location transmission (408), it determines if the mobile communication device is nearby (e.g., within a prescribed distance) one of the previously identified enterprises (410). If not, the provider waits to receive the next current location transmission from the mobile communication device (412) and repeats actions 408 and 410. However, whenever it is determined that the mobile communication device is proximate to one of the identified enterprises, the e-coupon provider sends a notice to the device (414). This notice informs the user of a nearby enterprise that was named in, or which sells the good or service identified in, the location-based reminder request. The mobile communication device receives the notice and informs the user in any appropriate manner (416). In addition, the e-coupon provider generates one or more e-coupons associated with the identified enterprises, which could be for the desired good or service (418), and provides the e-coupon(s) to the mobile communication device (420). Finally, the mobile communication device receives the e-coupon(s) (422) and displays them to the user (424).

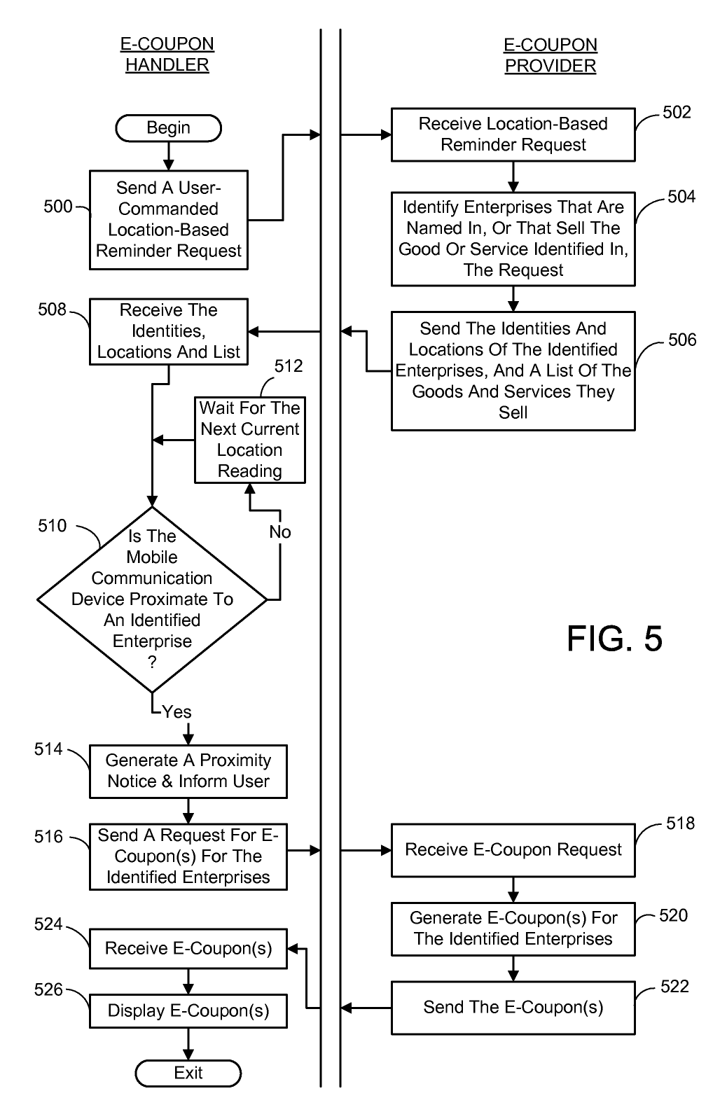

In the aforementioned second mode where the e-coupon handler of the mobile communication device does not provide current location to the e-coupon provider, the location-based reminder request is implemented, in one embodiment, as shown in FIG. 5. As before, a user-commanded location-based reminder request is sent from a user's mobile communication device to the e-coupon provider (500), and the provider receives it (502). The provider identifies enterprises that are named in, or that sell the good or service identified in, the request (504). However, in this case, the e-coupon provider sends the identities and locations of the identified enterprises, along with a list of the goods and services they sell, to the mobile communication device (506). The mobile communication device receives this information (508) and uses the last-ascertained current location to determine if it is nearby (e.g., within a prescribed distance) one of the identified enterprises (510). If not, the mobile communication device waits for the next time its current location is ascertained (512) and repeats actions 510 and 512. However, whenever it is determined that the mobile communication device is proximate to one of the identified enterprises, the device generates the aforementioned notice and informs the user of a nearby enterprise that was named in, or which sells the good or service identified in, the location-based reminder request (514). The mobile communication device then sends an e-coupon request to the e-coupon provider requesting one or more e-coupons corresponding to the identified enterprises (516). The e-coupon provider receives the e-coupon request (518) and generates e-coupon(s) associated with the identified enterprises (520), which could be for the desired good or service. The e-coupon(s) are then sent to the mobile communication device (522), which receives them (524) and displays them to the user (526).

### 2.1.3 Providing E-Coupons Based on Prior Purchasing Information

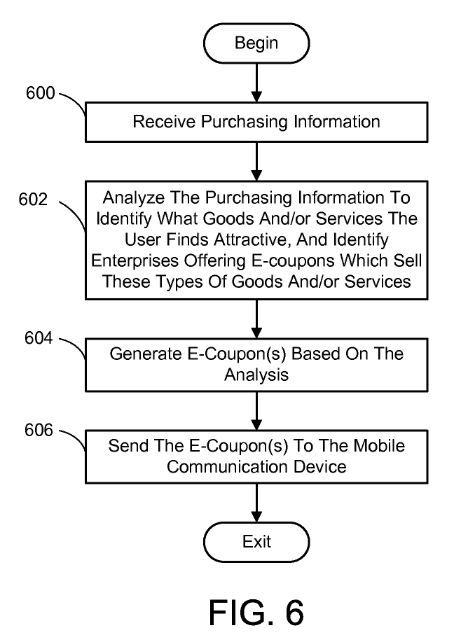

The e-coupon provider can also personalize the e-coupons it sends to a user's mobile communication device based on the user's prior purchasing history. FIG. 6 outlines one embodiment of the personalized e-coupon technique where the e-coupon provider provides one or more e-coupons to a user's mobile communication device based on this past purchasing information. First, the purchasing information is received by the e-coupon provider (600). This information can come from the aforementioned enterprises that offer e-coupons, or from third party purchasing data aggregation sources, or both. In addition, the purchasing information can be collected by the mobile communication device and provided to the e-coupon provider, as will be described later. In one embodiment of the present technique, the purchasing information includes data concerning a user's past redemption of e-coupons sent to the user. For example, this data could identify the goods or services purchased with an e-coupon. The data could also identify the price paid for the goods or services, as well. In order to associate the past e-coupon use to a particular user, the data can further identify the user, either by name or by an anonymous identifier (such as the aforementioned customer number).

The purchasing information is analyzed to identify what goods and/or services the user finds attractive and tends to buy, and to identify enterprises offering e-coupons which sell these types of goods and/or services (602). The analysis is then used to generate one or more e-coupons (604). For example, e-coupons associated with the aforementioned enterprises that sell the identified goods and services are identified in the analysis, could be generated. Any appropriate purchasing history analysis method can be employed to perform the foregoing analysis. Once the e-coupon(s) are generated, they are provided to the mobile communication device (606). The generating and providing of e-coupons can be done automatically by the e-coupon provider, or it could be done in response to a request for e-coupons from the user of the mobile communication device.

The foregoing embodiment of the personalized e-coupon technique where the e-coupon provider provides e-coupons to a user's mobile communication device based on the user's past purchasing information, could also be combined with the embodiment that provides e-coupons based on location information. In this combined embodiment, the analysis of the purchasing information is followed by a further analysis using the aforementioned location information to identify enterprises that are offering e-coupons and which are proximate to a frequent route or destination of the mobile communication device's user, or to the device current location of the device, or both. All the enterprises found could be used in generating the e-coupons, or just those that identified using the purchasing information and which are proximate a frequent route, destination or current location of the mobile communication device.

### 2.2 Personalized E-Coupon Handler Architecture

Referring to FIG. 7, the general architecture of the program modules making up the personalized e-coupon handler of the present technique is shown. As stated previously, the e-coupon handler resides in the computing portion of the mobile communication device. A receipt module 700 of the handler inputs e-coupons, notices, and other information 702 from the e-coupon provider. In one embodiment, the received information includes data representing one or more e-coupons and is forwarded to a display module 704. The display module processes the received e-coupon data in a conventional manner to render the e-coupon(s) and then outputs to a display of the mobile communication device. The display module 704 could also output e-coupon data for purposes of redeeming them in forms that do not involve displaying the e-coupons, as described previously.

In the context of the aforementioned location-based reminder request, the received information can also include either a proximity notice or information about the identities and locations of the identified enterprises along with a list of the goods and services they sell.

The e-coupon handler can optionally include a location module 706 for use in embodiments where the location of the mobile communication device is employed, such as when e-coupons are personalized based on the user's frequent routes, frequented destinations and/or current location. The location module 706 is also employed for location-based reminder requests. More particularly, the location module periodically captures the mobile communication device's current location. In embodiments of the present technique where the e-coupon provider analyzes current location data to establish frequent routes and destinations and provide e-coupons based on these or the mobile communication device's current location, or both, the location module 706 is responsible for providing this location information 708 to the e-coupon provider. In embodiments where the frequent routes and destination are established locally and then provided to the e-coupon provider, the location module 706 is responsible for using the current location data to establish the frequent routes and destination data and providing this information 708 to the e-coupon provider. In embodiments where the user initiates a location-based reminder request and the e-coupon provider is responsible for providing the proximity notice, it is the location module 706 that causes the request 710 to be sent to the provider and also provides the location information 708 needed to generate the notice to the provider. In embodiments where the user initiates a location-based reminder request and the e-coupon provider is asked to send information about the identities and locations of the identified enterprises along with a list of the goods and services they sell to the mobile communication device, it is the location module 706 that is responsible for making a request 712 for this data and then notifying the user when the mobile communication device is nearby one of the identified enterprises. The location module 706 is also responsible for making a request 714 for e-coupons associated with the proximate enterprises in this latter embodiment.

In embodiments of the present technique where e-coupons are generated and provided to the mobile communication device based prior purchasing information provided by the device itself, an optional analysis module 716 is included. In general, the analysis module 716 is responsible for tracking past e-coupon use and determining from this data what goods and services would be attractive to the user. This determination would be accomplished in the previously-described manner used by the e-coupon provider. For example, this data could identify the goods or services purchased with an e-coupon. The data could also identify the price paid for the goods or services, as well. In order to associate the past e-coupon use to a particular user, the data can further identify the user, either by name or by an anonymous identifier (such as the aforementioned customer number). The analysis module 716 is also responsible for sending the determination results, which represent the aforementioned purchasing information 718, to the e-coupon provider. As described previously, the e-coupon provider uses the purchasing information 718 to identify enterprises offering e-coupons that would be attractive to the user of the mobile communication device, and providing them either automatically or in response to an e-coupon request received from a mobile communication device. In this latter scenario, the analysis module 716 is responsible for sending the e-coupon request 720 to the provider.

It is noted that in the aforementioned combined embodiment where the e-coupon provider provides e-coupons to a user's mobile communication device based on the user's past purchasing information and location information, both the location and analysis modules would be included in the e-coupon handler.

In the above-described embodiments where the e-coupon provider pushes e-coupons to a mobile communication device, it is possible to add yet another optional module to the e-coupon handler running on the device-namely a filter module 722. In general, the filter module filters incoming e-coupons and prevents those that are not deemed to be attractive to the user of the mobile communication device from being displayed. More particularly, in one embodiment, the filter module 722 tracks the user's past redemption or non-redemption of e-coupons and determines from this data what goods and services would be attractive to the user. It is noted that this is the same task performed by the analysis module 716. Thus, if the analysis module 716 is present in the e-coupon handler, the information can be obtained from it. Otherwise, the filter module 722 would perform the tracking and determine what goods and services would be attractive to the user. Any e-coupons received from the e-coupon provider that did not correspond to these goods or services would be blocked from being processed by the display module 704.

In another embodiment of the filter module 722, location information associated with the mobile communication device is collected. For example, this information can include the mobile communication device's current location, frequent routes taken by the user, destinations frequented by the user, or any combination of these items. It is noted that this is the same task performed by the location module 706. Thus, if the location module 706 is present in the e-coupon handler, the information can be obtained from it. Otherwise, the filter module 722 would collect the location information. The filter module 722 analyzes the location information and blocks e-coupons received by the e-coupon provider that are not associated with enterprises located along a frequent route, or that are frequented destinations of the user, or that are not nearby the current location of the mobile communication device, from being processed by the display module 704.

The filter module 722 could also perform both the purchasing information-based and location-based filtering tasks. In this latter embodiment, only those e-coupons received by the e-coupon provider that correspond to the goods or services deemed to be attractive to the user, and which are associated with enterprises located nearby a frequent route, frequented destination or current location of the mobile communication device, are processed by the display module 704.

It is noted that when the e-coupon provider has generated e-coupons based on the user's purchasing or location information, or both, the corresponding filtering by the e-coupon handler could be omitted. In addition, as the user's travel habits and purchasing patterns may change over time, the filter module 722 periodically update the information to keep it current.

### 2.2.1 Personalized E-Coupon Handling Operations

Given the above-described architecture of the e-coupon handler, the following section will describe personalized e-coupon handling operations that employ the architecture to receive and display e-coupons to a user of a mobile communication device. It will be assumed for the description that all the foregoing e-coupon handler modules are present. If a module is not present, the operations associated with it would be skipped.

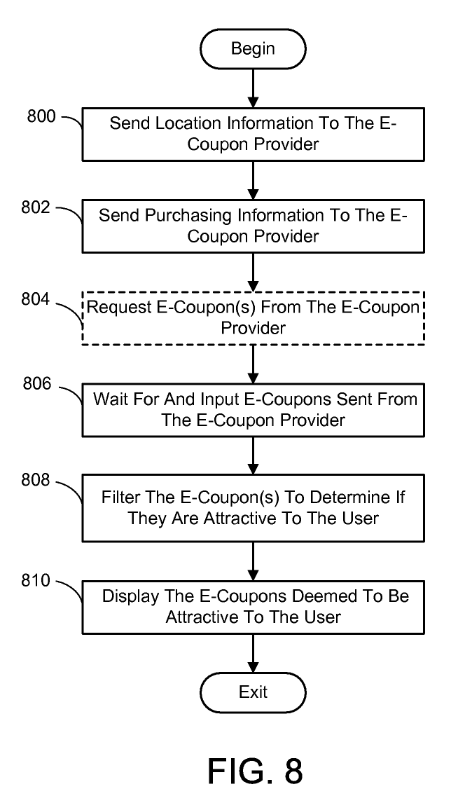

Referring to FIG. 8, one embodiment of the e-coupon handing operations involve first sending location information to the e-coupon provider (800). In addition, purchasing information is also sent to the provider (802). If either (or both) of these types of information are not needed by the e-coupon provider to generate e-coupons, the e-coupon handler could omit sending the unnecessary information. Optionally, if the e-coupon technique allows the user of a mobile communication device to request coupons, such a request can be sent (as indicated by the broken line box 804 in FIG. 8). The e-coupon handler waits for e-coupons to be sent from the provider, and inputs each e-coupon upon receipt (806). The inputted e-coupons are each filtered as described previously (if necessary) to determine whether it is to be deemed attractive to the user (808). Those e-coupons that are deemed attractive are displayed to the user on the display of the mobile communication device (810).

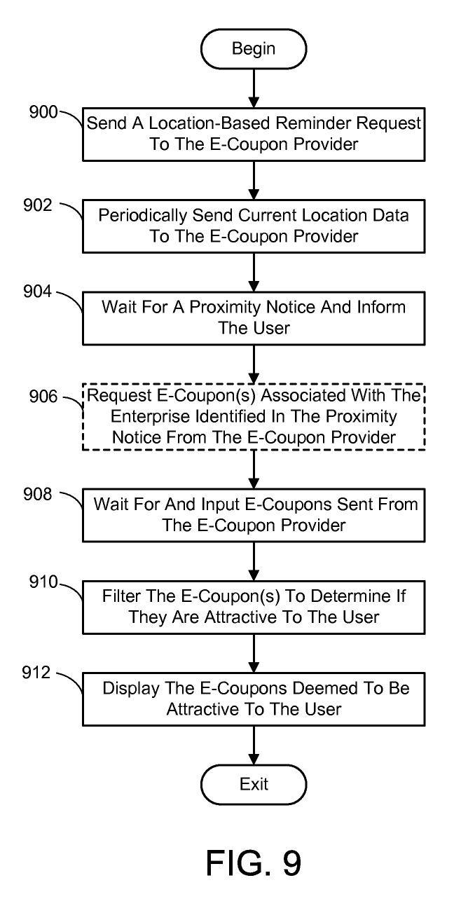

Referring to FIG. 9, an embodiment of the e-coupon handing operations involving a location-based reminder request using e-coupon provider generated notification is illustrated. The operation begins by sending the location-based reminder request to the e-coupon provider (900). This is followed by periodically sending location information in the form of current location data to the provider (902). As described previously, the e-coupon provider determines when the mobile communication device comes near an enterprise named in, or that sells the good or service identified in, the reminder request. When it is determined the mobile communication device is near such an enterprise, it sends a notice to the user via the device. Thus, the e-coupon handler waits for the notice and passes it along to the user (904). Optionally, the handler can then send a request for e-coupons to the e-coupon provider for e-coupons associated with each enterprise listed in the notice (906). This would be done in embodiments of the present technique where e-coupons are not automatically sent to the mobile communication device. The e-coupon handler waits for e-coupons to be sent from the provider, and inputs each e-coupon upon receipt (908). The inputted e-coupons are each filtered as described previously (if necessary) to determine whether it is to be deemed attractive to the user (910). Those e-coupons that are deemed attractive are displayed to the user on the display of the mobile communication device (912).

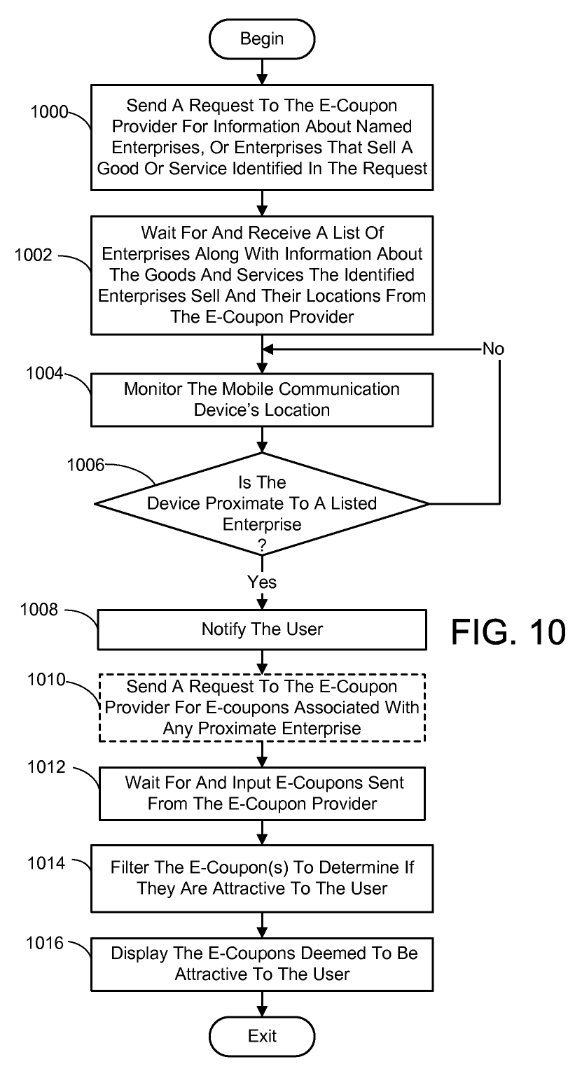

Referring to FIG. 10, an embodiment of the e-coupon handing operations involving a location-based reminder request using a e-coupon handler generated notification is illustrated. The operation begins by sending a request to the e-coupon provider for information about named enterprises, or enterprises that sell a good or service identified in the request (1000). The e-coupon handler waits for and receives a list of enterprises along with information about the goods and services the identified enterprises sell and their locations from the e-coupon provider (1002). The e-coupon handler then monitors the mobile communication device's location (1004) and determines if the device is proximate to any of the listed enterprises (1006). If not, the monitoring continues by repeating actions (1004) and (1006). When it is determined the mobile communication device is proximate to a listed enterprise, the user is notified (1008). Optionally, the handler can then send a request to the e-coupon provider for e-coupons associated with the proximate enterprise (1010). The e-coupon handler waits for e-coupons to be sent from the provider, and inputs each e-coupon upon receipt (1012). The inputted e-coupons are each filtered as described previously (if necessary) to determine whether it is to be deemed attractive to the user (1014). For example, e-coupons corresponding to a good or service that was the subject of the aforementioned location-based reminder request would likely be attractive to the user. Those e-coupons that are deemed attractive are then displayed to the user on the display of the mobile communication device (1016).

### 3.0 Other Embodiments

In the foregoing description of embodiments for the present e-coupon technique, the e-coupon provider was described in terms of providing e-coupons associated with a plurality of enterprises. However, the present technique can also be implemented in a simpler form where the e-coupon provider is dedicated to providing e-coupons of a single enterprise. The architecture and operation of the e-coupon provider is substantially the same, but may operate on a more localized level. Thus, e-coupons would still be provided to a user's mobile communication device based on the user's location or e-coupon purchasing history, or both. However, for example, rather than providing proximity notices for different enterprises, the notices could be issued for different departments within a single enterprise. Further, when the user is shopping at the enterprise, the e-coupon provider could communicate with the user's mobile communication device using a localized wireless format, such as bluetooth or wi-fi. For example, an enterprise would install a bluetooth or wi-fi terminal at their location. When a participating mobile communication device user walks into the location, he or she uses their device to connect to the terminal to request e-coupons and notices, and to receive e-coupons personalized for them.

It should also be noted that any or all of the aforementioned embodiments throughout the description may be used in any combination desired to form additional hybrid embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for providing personalized e-coupons to a user of a mobile communication device which is capable of ascertaining its location, comprising using a computer to perform the following process actions:
receiving location information associated with the mobile communication device (300), wherein the location information comprises routes and destinations frequented by the user in that the user took a route at least a first prescribed number of times and visited a destination at least a second prescribed number of times, as derived from location data periodically captured by the mobile communication device;
analyzing the location information to identify enterprises offering e-coupons which are proximate within a first prescribed distance to a frequent route or a second prescribed distance to a destination of the user (302);
generating one or more e-coupons associated with the identified enterprises (306); and
providing the generated e-coupons to the mobile communication device (308).

2. The process of claim 1, wherein the location information further comprises the current location of the mobile communication device, and wherein the process further comprises the process actions of:
identifying enterprises offering e-coupons which are within a third prescribed distance of the current location of the mobile communication device;
generating one or more e-coupons associated with one or more of the identified enterprises which are within said third prescribed distance of the current location of the mobile communication device; and
providing the generated e-coupons associated with the one or more of the identified enterprises which are within said third prescribed distance of the current location of the mobile communication device, to the mobile communication device.

3. The process of claim 1, wherein the location information further comprises the current location of the mobile communication device, and wherein the process further comprises the process actions of:
receiving a location-based reminder request for the user of the mobile communication device, said request identifying a good or service that the user wishes to purchase, or an enterprise the user wishes to shop at;
identifying enterprises named in, or that sell the good or service identified in, the location-based reminder request;
periodically receiving data identifying the current location of the user from the mobile communication device; and
whenever, based on the current location data, the mobile communication device is proximate within said third prescribed distance to an identified enterprise named in or that sells the good or service identified in the request, notifying the user associated with the request of the nearby enterprise.

4. The process of claim 3, further comprising the process actions of:
generating one or more reminder request e-coupons associated with the good or service identified in the location-based reminder request, or offered by the enterprise identified in the request; and
providing the one or more generated reminder request e-coupons to the mobile communication device.

5. The process of claim 1, wherein the location information further comprises the current location of the mobile communication device, and wherein the process further comprises the process actions of:
receiving a location-based reminder request for the user of the mobile communication device, said request identifying a good or service that the user wishes to purchase, or an enterprise the user wishes to shop at;
identifying enterprises named in, or that sell the good or service identified in, the location-based reminder request; and
providing the identities and locations of the identified enterprises, as well as a list of goods and services the enterprises sell, to the mobile communication device, thereby facilitating the mobile communication device notifying the user whenever the device is proximate within said third prescribed distance to an identified enterprise named in, or that sells the good or service identified, in the location-based reminder request.

6. The process of claim 5, further comprising the process actions of:
receiving an e-coupon request for one or more e-coupons corresponding to the good or service identified in the location-based reminder request, or offered by the enterprise identified in the request;
generating the one or more requested e-coupons; and
providing the one or more requested e-coupons to the mobile communication device.

7. A system for providing personalized e-coupons to a user of a mobile communication device, comprising:
a general purpose computing device which is capable of communicating with said mobile communication device; and
a computer program comprising program modules executable by the computing device, wherein the computing device is directed by the program modules of the computer program to,
receive purchasing information (200), wherein the purchasing information comprises data concerning a user's past redemption of e-coupons,
analyze the purchasing information to determine what goods or services, or both, the user finds attractive (204),
generate one or more e-coupons based on the analysis of the purchasing information (206), and
provide the generated e-coupons to the mobile communication device (208).

8. The system of claim 7, wherein the data concerning a user's past redemption of e-coupons comprises a good or service purchased with an e-coupon.

9. The system of claim 8, wherein the data concerning a user's past redemption of e-coupons further comprises the price of the good or service purchased with the e-coupon.

10. The system of claim 7, wherein the data concerning a user's past redemption of e-coupons comprises an indicator identifying the user who redeemed the e-coupon.

11. The system of claim 7, wherein the program modules for generating and providing one or more e-coupons to the mobile communication device, comprises sub-modules for generating and providing one or more e-coupons in response to a request for e-coupons received from the user of the mobile communication device.

12. The system of claim 7, wherein the mobile communication device is capable of ascertaining its location, and wherein the program modules for generating and providing one or more e-coupons to the mobile communication device, comprises sub-modules for generating and providing one or more e-coupons associated with enterprises located within a prescribed distance from the location of the mobile communication device based on location information received from the mobile communication device.

13. The system of claim 7, wherein the mobile communication device is capable of ascertaining its location, and wherein the program modules for generating and providing one or more e-coupons to the mobile communication device, comprises sub-modules for generating and providing one or more e-coupons associated with enterprises located within a prescribed distance from the mobile communication device based on location information received from the mobile communication device in a request for said e-coupons.

14. A computer-readable medium having computer-executable instructions for receiving a personalized e-coupon on a mobile communication device comprising a display, said computer-executable instructions comprising:
inputting an e-coupon sent by an e-coupon provider on said mobile communication device (806), wherein the e-coupon is redeemable for a good or service that is deemed to be attractive to the user of the mobile communication device based on the user's past redemption and non-redemption of e-coupons; and
displaying the inputted e-coupon on the display of the mobile communication device, said e-coupon being redeemable by the user (810).

15. The computer-readable medium of claim 14, wherein the inputted e-coupon comprises an indicator identifying the user such that whenever the e-coupon is redeemed, the user redeeming the e-coupon is known.

16. The computer-readable medium of claim 14, wherein the mobile communication device is capable of ascertaining its location, and wherein the medium further comprises instructions for:
causing the mobile communication device to send a location-based reminder request to the e-coupon provider in response to a user command to do so, wherein the request identifies a good or service the user wishes to purchase, or an enterprise the user wishes to shop at;
periodically causing the mobile communication device to send data identifying its current location to the e-coupon provider; and
receiving a notification from the e-coupon provider that the mobile communication device is within a prescribed distance from an enterprise named in, or that sells the good or service identified in, the location-based reminder request.

17. The computer-readable medium of claim 16, further comprising an instruction for displaying an e-coupon associated with the good or service identified in the location-based reminder request, or offered by the enterprise identified in the request, whenever such an e-coupon is received from the e-coupon provider.

18. The computer-readable medium of claim 14, wherein the mobile communication device is capable of ascertaining its location, and wherein the medium further comprises instructions for:
causing the mobile communication device to send a location-based reminder request to the e-coupon provider in response to a user command to do so, wherein the request identifies a good or service the user wishes to purchase, or an enterprise the user wishes to shop at;
receiving from the e-coupon provider, a list of one or more enterprises and their locations corresponding to an enterprise that was named in, or that sells the good or service identified in, the location-based reminder request;
notifying the user that the mobile communication device is within a prescribed distance from a listed enterprise.

19. The computer-readable medium of claim 18, further comprising instructions for:
causing the mobile communication device to send an e-coupon request to the e-coupon provider requesting one or more e-coupons corresponding to the good or service identified in the location-based reminder request, or offered by an enterprise identified in the request; and
displaying the one or more requested e-coupons whenever received from the e-coupon provider.

20. The computer-readable medium of claim 14, wherein the mobile communication device is capable of ascertaining its location, and wherein the instruction for displaying an e-coupon sent by an e-coupon provider, comprises sub-instructions for:
collecting location information associated with the mobile communication device, wherein the location information comprises the mobile communication device's current location, as well as routes and destinations frequented by the user in that the user took a route at least a first prescribed number of times and visited a destination at least a second prescribed number of times; and
analyzing the location information and the user's past redemption and non-redemption of e-coupons to filter e-coupons sent by the e-coupon provider and only displaying an e-coupon that is deemed to be attractive to the user based on past e-coupon redemption and non-redemption, and associated with enterprises located within a first prescribed distance of the mobile communication device's current location or a frequented destination, or located within a second prescribed distance from a frequented route.
